(19) United States
(12) Patent Application Publication
(10) Pub. No.: US 2015/0008216 A1
(43) Pub. Date: Jan. 8, 2015

(54) Cooking Hob and Operation Method Thereof

(71) Applicant: Electrolux Professional S.p.a., Pordenone (IT)

(72) Inventor: Ennio PIPPIA, San Giorgio di Nogaro (IT)

(73) Assignee: Electrolux Professional S.p.a., Pordenone (IT)

(21) Appl. No.: 14/321,264

(22) Filed: Jul. 1, 2014

(30) Foreign Application Priority Data
Jul. 3, 2013 (EP) 13174896.4

(51) Int. Cl. H05B 6/06; H05B 1/02

(52) U.S. Cl. CPC H05B 6/065; H05B 1/0266
USPC 219/627; 219/664

(57) ABSTRACT

A method (200;300;400) for operating a cooking hob (100) is proposed. The cooking hob comprises at least a first (115₁) and a second (115₆) cooking zones and a control unit (135) configured for controlling the first and second cooking zones. The method comprises the following steps executed by the control unit. A pan (P₁) containing food to be cooked is associated (210;305;405) to the first cooking zone; a food temperature sensor (Ts) is associated (215;310;405) to the first cooking zone, the food temperature sensor being configured to be in direct contact with the food to be cooked and to communicate to the control unit an indication of the food temperature; a power level of the first cooking zone is automatically adjusted (225;320;420) according to a cooking recipe (CR₁) and to the current food temperature provided by the food temperature sensor; food movement from the first cooking zone to the second cooking zone is inferred (230-235;325-330,345-360;425-430,445-460) based on a de-association (235;330,345;430,445) of the food temperature sensor from the first cooking zone and a re-association (235;330,355;430,455) of the food temperature sensor to the second cooking zone; and the power level of the second cooking zone is automatically adjusted (240;335,365;435,465) according to the cooking recipe and to the current food temperature provided by the food temperature sensor, starting from a progress status of the cooking recipe at the first cooking zone before moving the food.

### CROSS-REFERENCE TO RELATED APPLICATION

This application claims priority to European Application No. 13174896.4, filed on Jul. 3, 2013, the content of which is hereby incorporated by reference in its entirety.

### BACKGROUND OF THE INVENTION

The present invention generally relates to an improved cooking hob for food cooking, for example an induction hob.

A conventional induction hob comprises a glass-ceramic solid plate, as well as a number of conductive coils placed underneath it and selectively operable for defining one or more cooking zones.

During operation, after a ferromagnetic cooking pan containing food to be cooked is rested on a cooking zone, an alternating electric current is allowed to flow through the respective coil(s), thus generating an oscillating magnetic field. According to well known physical principles, such magnetic field induces an eddy current in the pan, which in turns produces, by Joule effect, resistive heating thereof and hence of the food contained therein.

The induction effect causes heating only of the pan bottom, and only upon contact thereof with the plate. Therefore, the induction hob prevents burn injury when touching any plate area free from pans or in close proximity thereto. Moreover, thanks to poor heat-conducting properties of the glass-ceramic material, burn injury is also significantly reduced for those plate areas (of activated cooking zone(s)) which the pan has just been removed from.

Induction hobs also provide a certain degree of customization, such as cooking zones selection according to pan size and automatic pan detection, as well as more precise and uniform heating of the cooking zones.

Modern induction hobs are also equipped with functionalities that make them increasingly attractive for users.

Such functionalities may comprise automatic food cooking, such as automatic control of cooking zones power according to a predefined power/time trend selected by the user (hereinafter, cooking recipe), and dynamic interaction with external cooking utilities, such as control of cooking zones power according to cooking information returned by such utilities.

For example, EP1588586 discloses a temperature sensor, integrated within a pan handle, adapted to wirelessly return temperature information to the induction hob, and a RFID chip, also integrated within the pan handle, adapted to store and transmit information about the ongoing cooking recipe. Such document further discloses an induction hob adapted to continue the cooking recipe when, before its ending, the pan is moved to another cooking zone.

### SUMMARY OF SELECTED INVENTIVE ASPECTS

The Applicant has found that the known induction hobs are not configured to perform really smart cooking

In fact, currently marketed induction hobs are not able to autonomously and dynamically adapt to changeable scenarios typical of cooking processes.

For example, the possibility of continuing a cooking recipe in EP1588586 is significantly limited to the use of a specifically designed pan, and only to the particular scenario where the pan is moved from a cooking zone to another one. Other relatively usual scenarios are instead not considered, such as food movement from a pan to another one.

Moreover, the Applicant has understood that a really smart and precise cooking requires adequate food temperature sensing. In this respect, according to the Applicant, temperature sensors integrated within the pan, or the pan handle, can not provide accurate food temperature, as heat transfer between the pan and food strongly depends on thermal properties thereof. Thus, non-ideal food cooking is typically experienced.

The Applicant has also understood that a really smart control of cooking zones power is incompatible with cooking recipes based on predefined power/time trends (such as those selectable in most of modern induction hobs), as effective power transferred between coil(s) and pan strongly depends on electromagnetic properties thereof.

The Applicant has faced the problem of devising a satisfactory solution able to overcome the above-discussed drawbacks.

In particular, one or more aspects of the solution according to specific embodiments of the invention are set out in the independent claims, with advantageous features of the same solution that are indicated in the dependent claims (with any advantageous feature provided with reference to a specific aspect of the solution according to an embodiment of the invention that applies mutatis mutandis to any other aspect thereof).

An aspect of the solution according to one or more embodiments of the present invention relates to a method for operating a cooking hob comprising at least a first and a second cooking zones and a control unit configured for controlling the first and second cooking zones. The method comprises the following steps executed by the control unit:
associating a pan containing food to be cooked to the first cooking zone,
associating a food temperature sensor to the first cooking zone, the food temperature sensor being configured to be in direct contact with the food to be cooked and to communicate to the control unit an indication of the food temperature,
automatically adjusting a power level of the first cooking zone according to a cooking recipe and to the current food temperature provided by the food temperature sensor,
inferring that the food has been moved from the first cooking zone to the second cooking zone based on a de-association of the food temperature sensor from the first cooking zone and a re-association of the food temperature sensor to the second cooking zone, and
automatically adjusting the power level of the second cooking zone according to the cooking recipe and to the current food temperature provided by the food temperature sensor, starting from a progress status of the cooking recipe at the first cooking zone before moving the food.

According to an embodiment of the present invention, said inferring is further based on:
de-association of the pan from the first cooking zone and re-association of the pan to the second cooking zone, or
association of a further pan to the second cooking zone.

According to an embodiment of the present invention, the method further comprises:
inferring that the food has not been moved from the first cooking zone to the second cooking zone based on
   no de-association of the pan from the first cooking zone and no re-association of the pan to the second cooking zone, or based on
   no association of the further pan to the second cooking zone, and
automatically adjusting the power level of the first cooking zone.

According to an embodiment of the present invention, said inferring is further based on de-association of the pan from the first cooking zone and re-association of the pan to the second cooking zone.

According to an embodiment of the present invention, said inferring is further based on:
no de-association of the pan from the first cooking zone and no re-association of the pan to the second cooking zone,
association of a further pan to the second cooking zone, and
selection of the cooking recipe for the second cooking zone.

According to an embodiment of the present invention, upon
no de-association of the pan from the first cooking zone and no re-association of the pan to the second cooking zone,
association of the further pan to the second cooking zone, and
selection of a further cooking recipe for the second cooking zone,
the method further comprises automatically adjusting the power level of the second cooking zone according to the further cooking recipe and to current food temperature provided by the food temperature sensor.

According to an embodiment of the present invention, the method further comprises:
inferring that the food has not been moved from the first cooking zone to the second cooking zone based on
   no de-association of the pan from the first cooking zone and no re-association of the pan to the second cooking zone, and
   no association of the further pan to the second cooking zone, and
automatically adjusting the power level of the first cooking zone.

According to an embodiment of the present invention, said automatically adjusting the power level of the first cooking zone comprises automatically setting the power level of the first cooking zone at a predefined power level.

According to an embodiment of the present invention, said predefined power level is set according to the progress status of the cooking recipe before de-association of the temperature sensor from the first cooking zone.

According to an embodiment of the present invention, said automatically adjusting the power level of the first cooking zone comprises automatically adjusting the power level of the first cooking zone according to the cooking recipe, starting from the progress status thereof before de-association of the food temperature sensor from the first cooking zone.

According to an embodiment of the present invention, the method further comprises, before said de-association of the food temperature sensor from the first cooking zone and re-association of the food temperature sensor to the second cooking zone, automatically detecting food temperature sensor movement from the first cooking zone to the second cooking zone.

According to an embodiment of the present invention, the method further comprises, before said de-association of the pan from the first cooking zone and re-association of the pan to the second cooking zone, automatically detecting pan movement from the first cooking zone to the second cooking zone.

Another aspect of the solution according to one or more embodiments of the present invention relates to a cooking hob. The cooking hob comprises at least a first and a second cooking zones, and a control unit configured for:
associating a pan containing food to be cooked to the first cooking zone,
associating a food temperature sensor to the first cooking zone, the temperature sensor being configured to be in direct contact with the food to be cooked and to communicate to the control unit an indication of the food temperature,
automatically adjusting a power level of the first cooking zone according to a cooking recipe and to the current food temperature provided by the food temperature sensor,
inferring that the food has been moved from the first cooking zone to the second cooking zone based on a de-association of the food temperature sensor from the first cooking zone and a re-association of the food temperature sensor to the second cooking zone, and
automatically adjusting the power level of the second cooking zone according to the cooking recipe and to the current food temperature provided by the food temperature sensor, starting from a progress status of the cooking recipe at the first cooking zone before moving the food.

According to an embodiment of the present invention, the cooking hob further comprises at least one electronic module allowing information exchange between the control unit and the food temperature sensor.

According to an embodiment of the present invention, said at least one electronic module comprises a wireless electronic module configured for
wireless exchange of said information with the temperature sensor, and
wired exchange of said information with the control unit.

According to an embodiment of the present invention, the cooking hob comprises an induction hob.

The method and the induction hob of the present invention feature a smart cooking mode allowing to continue an ongoing cooking recipe in different scenarios, for example both when pan is moved from a cooking zone to another one, and when food is moved from a pan to another one. Furthermore, the proposed smart cooking mode allows quickly, efficiently and smartly recognizing, and responding to, other possible, relatively usual user operations during a cooking process. This is achieved without requiring any specifically designed pan. Indeed, recognizing of all possible scenarios is based on recognizing movements and/or associations/de-associations/re-associations of pan and/or of temperature sensor in the cooking zone. This strongly improves user experience and avoids continuous user intervention, being pan/temperature sensor movements/associations/de-associations/re-associations natural and easy gestures.

In order to achieve that, the temperature sensor is external to, i.e. not integrated within, the pan, and may be (operatively) coupled to/decoupled from the pan at user discretion. Structural separation between pan and temperature sensor also allows proper positioning of the temperature sensor. In this respect, the proposed solution is based on direct food temperature sensing, which is achieved by positioning the temperature sensor in direct contact with the food to be cooked. This allows ideal food cooking irrespective of coil(s)/pan electromagnetic coupling and/or pan/food thermal coupling (that instead affect known solutions based on control of cooking zones power according to power/time trends).

Moreover, the use of cooking recipes involves high ease for the user. Indeed, the user selects the food to be cooked, the degree of cooking, and/or type/level of food treatment, each selection corresponding to a cooking recipe having a specific temperature/time trend. This makes user selection simple and intuitive.

### BRIEF DESCRIPTION OF THE DRAWINGS

These and other features and advantages of the solution according to one or more embodiments of the invention will be best understood with reference to the following detailed description, given purely by way of a non-restrictive indication, to be read in conjunction with the accompanying drawings (wherein corresponding elements are denoted with equal or similar references, and their explanation is not repeated for the sake of exposition brevity). In this respect, it is expressly understood that the figures are not necessarily drawn to scale (with some details that may be exaggerated and/or simplified) and that, unless otherwise indicated, they are simply used to conceptually illustrate the described structures and procedures. In particular:

FIG. 1 schematically shows a perspective and partly see-through view of an induction hob according to an embodiment of the present invention;

FIG. 2 shows a simplified activity diagram of an operation mode of the induction hob of FIG. 1 according to an embodiment of the present invention;

FIG. 3A-3B show a simplified activity diagram of an operation mode of the induction hob of FIG. 1 according to another embodiment of the present invention;

FIGS. 4A-4B show a simplified activity diagram of an operation mode of the induction hob of FIG. 1 according to a further embodiment of the present invention, and

FIGS. 5A-5D schematically show perspective views of some possible scenarios contemplated by such operation modes.

### DETAILED DESCRIPTION OF EXAMPLE EMBODIMENTS

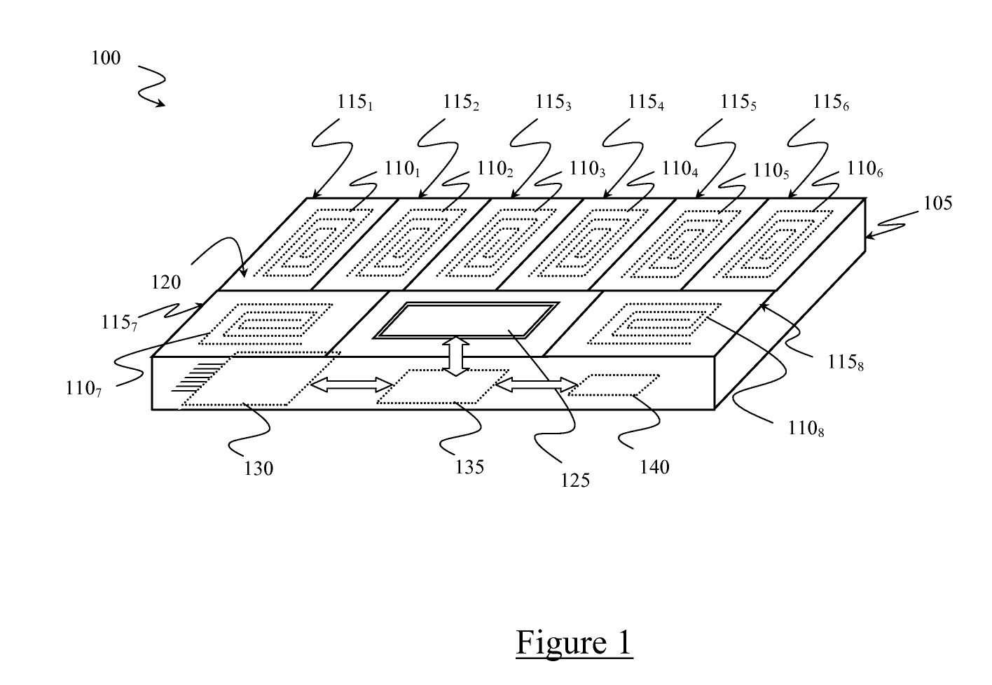

With reference to the drawings, an induction hob 100 according to an embodiment of the present invention is schematically shown in FIG. 1. For the sake of illustration ease, components of the induction hob 100 otherwise not visible are represented by dashed lines in such figure.

The induction hob 100 comprises a solid plate 105, for example made of glass-ceramic material, and a number N of electrically activatable conductive coil members, or coils, 110ᵢ (i=1, 2, . . . , N, with N=8 in the example at issue), for allowing cooking processes by induction. The coils 110ᵢ are placed in succession underneath the plate 105 and identify, on a top surface 120 of the plate 105, corresponding cooking zones 115ᵢ of the induction hob 100. In the example at issue, cooking zones default layout features six side by side rectangular-shaped upper cooking zones 115₁-115₆ (or back cooking zones, i.e. the cooking zones that are farther with respect to the front side of the induction hob 100), and two opposite rectangular-shaped lower cooking zones 115₇,115₈ (or front cooking zones, i.e. the cooking zones that are closer with respect to the front side of the induction hob 100) turned by 90° with respect to the upper cooking zones 115₁-115₆, although this should not be construed limitatively.

A control panel 125 featuring a user interface allowing to select/enable operation modes or settings of the induction hob 100 is provided on a free region of the top surface 120, for example between the lower cooking zones 115₇ and 115₈. Anyway, as should be readily understood, the control panel 125 can be arranged in any suitable region of the top surface 120, or even away from it. In the latter case, a remote control panel can be used.

In order to allow operation of the induction hob 100, a number of well-known electronic, mechanical and/or electro-mechanical components are provided underneath the plate 105—however, for the sake of ease and conciseness, only the relevant ones for discussing the invention will be introduced and considered hereinafter.

In this respect, the induction hob 100 comprises a driving circuit 130 for electrically activating/driving the coils 110ᵢ (connections not shown), and a control unit 135 for properly controlling the driving circuit 130 according to user selections at the control panel 125.

As usual, the driving circuit 130 may comprise inverters, rectifiers, filters and/or the like, whereas the control unit 135 may comprise one or more programmable microcontrollers and/or microprocessors.

In the example at issue, the induction hob 100 features automatic pan detection, i.e. automatic detection of pan position and pan movement on the plate 105. Automatic pan detection is achieved by cooperation between the control unit 135 and the coils 110, and possibly with other detecting units (such as weight sensors), not shown. From now on, automatic pan detection also involves automatic pan association/re-association to the cooking zone(s) at least partly covered by it, and automatic pan de-association from the cooking zone(s) when the pan is detected as moved away from.

Automatic pan detection can be achieved by known techniques, for example by the techniques described in patent EP2211591B1 or in patent EP1688018B1.

The induction hob 100 further comprises a communication module 140, or more of it, for allowing information exchange between the control unit 135 and external cooking utilities (e.g., food temperature sensors). In the example at issue, the communication module 140 is configured to allow wireless information exchange with the cooking utilities, and wired information exchange with the control unit 135. Such information may comprise cooking information returned by such utilities, identifiers for univocally identifying the cooking utilities, and/or position signaling for univocally determining the position of the cooking utilities (so as to allow automatic detection thereof, i.e. automatic detection of cooking utilities position and cooking utilities movement on the plate 105).

According to the present invention, the control unit 135 is configured to implement an operation mode, hereinafter smart cooking mode, aimed at providing smart and highly automated food cooking.

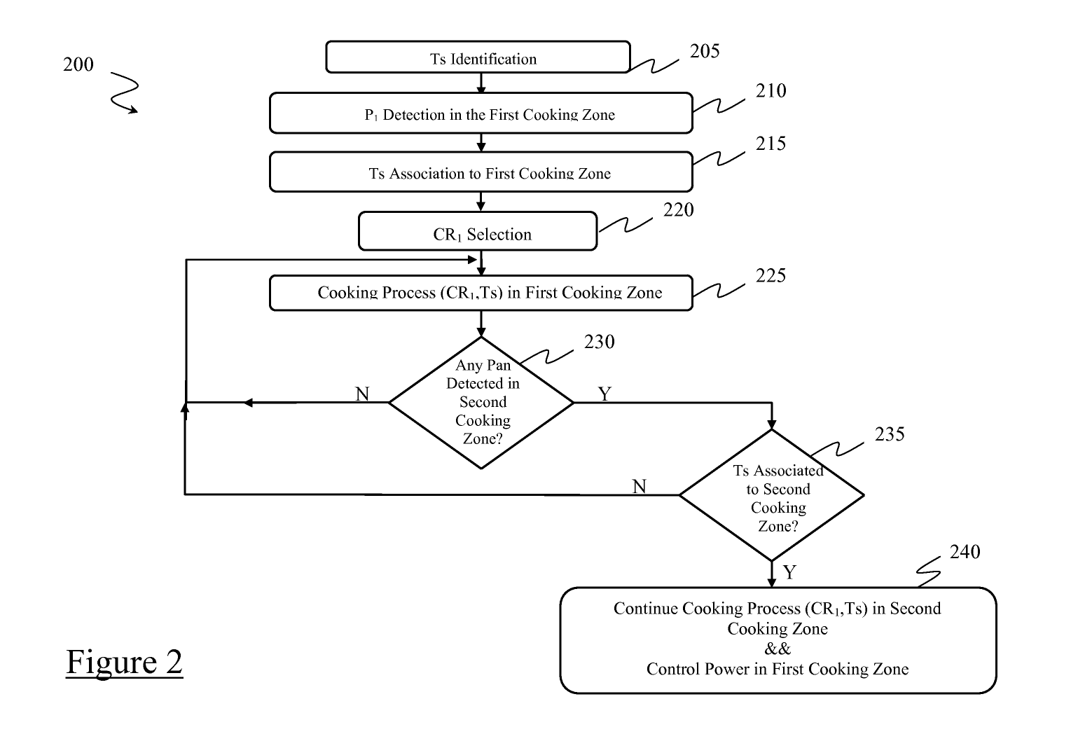

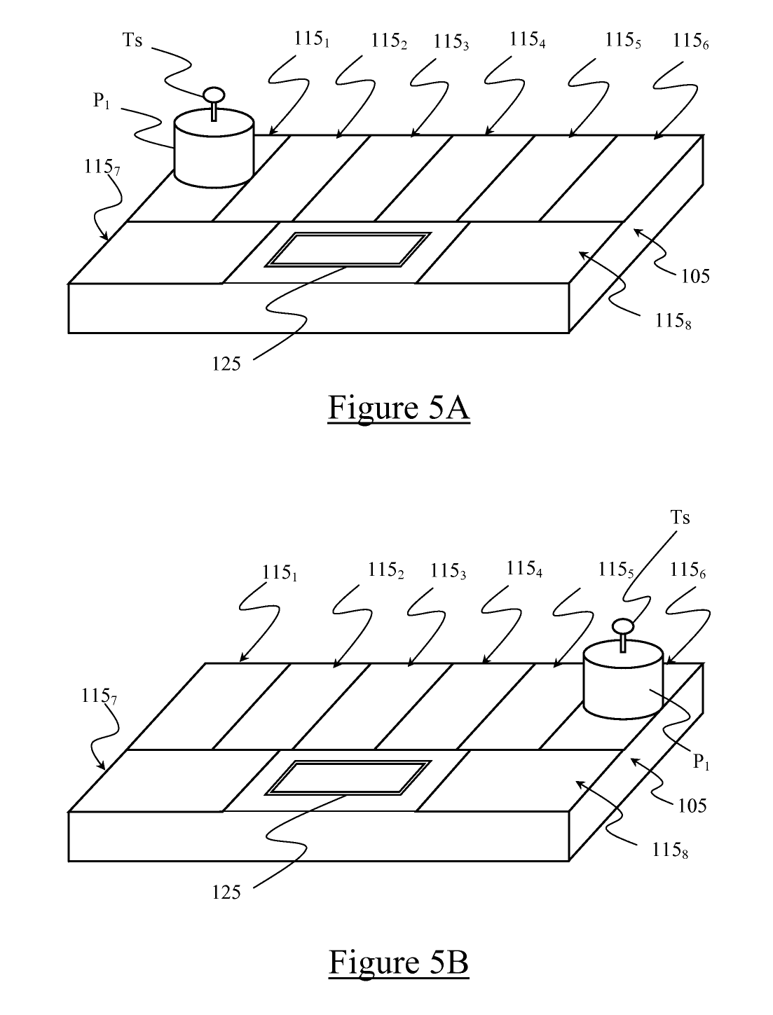

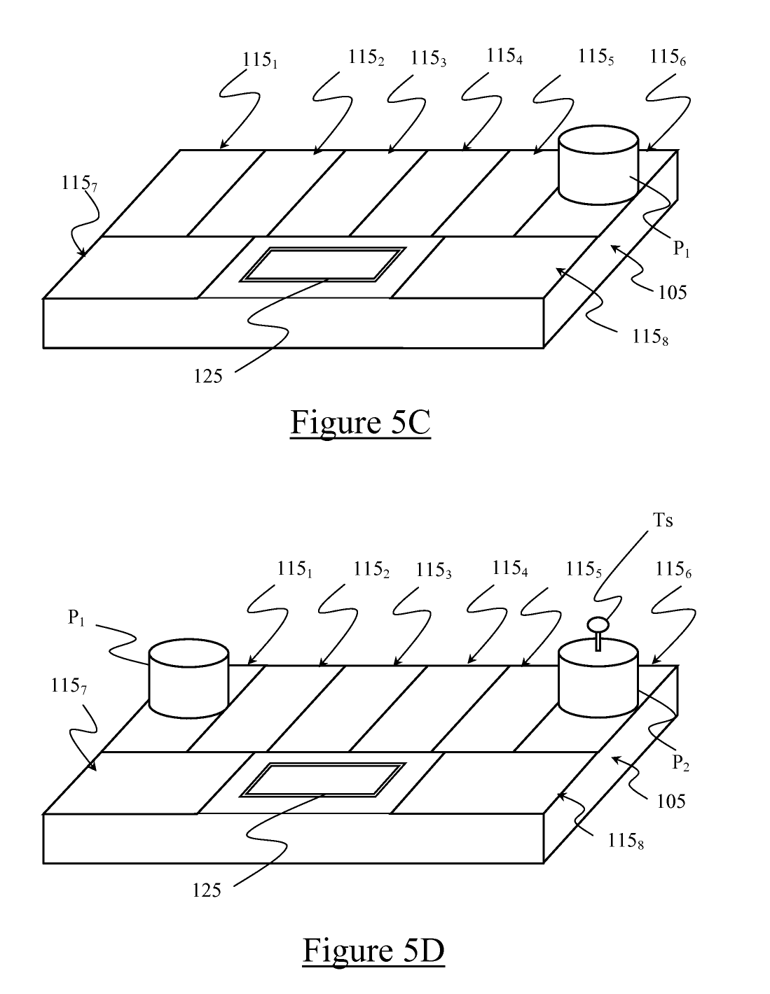

In this respect, reference will be now made to FIG. 2, which shows a simplified activity diagram of a smart cooking mode 200 according to an embodiment of the present invention, together with FIGS. 5A-5D, the latter schematically showing perspective views of possible cooking scenarios.

Let be considered the scenario illustrated in FIG. 5A, wherein a pan P₁ containing food to be cooked is placed on an area of the plate 105 identifying a first cooking zone (e.g., the cooking zone 115₁), together with a wireless food temperature sensor Ts.

Temperature sensor Ts may be for example a food temperature probe like the one described in patent EP0601137B1.

The temperature sensor Ts is configured to be in direct contact with the food to be cooked, or under cooking, for repeatedly measuring, and preferably storing, temperature thereof, and to wirelessly communicate food temperature (or an indication thereof) to the communication module, and hence to the control unit. In the example at issue, the temperature sensor Ts is also configured to communicate its identifier, so that the control unit is allowed to determine the presence of temperature sensor Ts near it.

As should be readily understood, the present invention, being based on direct food temperature sensing made possible by structural separation between temperature sensor Ts and pan P₁, allows performing ideal food cooking, irrespective of pan P₁ and food. This is in sharp contrast to known solutions making use of pans incorporating temperature sensors. Indeed, these are intrinsically imprecise as, at a certain pan temperature, the heat actually transferred to food strongly depends on specific pan/food thermal coefficients.

Smart cooking mode 200 operation can be summarized as follows.

Firstly, temperature sensor Ts identification (action node 205), detection of pan P₁ in the first cooking zone 115₁ (action node 210), and (manual or automatic) association of the temperature sensor Ts to the first cooking zone 115₁ (action node 215), are performed (not necessarily in this order).

After that, the user is requested to select or to set a cooking recipe CR₁ (action node 220). The cooking recipe CR₁ preferably comprises a temperature/time trend associated to the food to be cooked, to a type of cooking (e.g., roasting, broiling, grilling, frying, boiling, simmering, steaming), to a degree of cooking (e.g., well-cooked, half-cooked, undercooked food), and/or to a type/level of food treatment (e.g., pasteurization and pasteurization level).

Then, a cooking process is run under the control of the control unit (action node 225). During the cooking process, the control unit controls the driving circuit such as to automatically adjust power level of the cooking zone 115₁ according to the selected cooking recipe CR₁ and to current food temperature provided by the temperature sensor Ts. In other words, basing on current food temperature provided by the temperature sensor Ts, the power level of the cooking zone 115₁ is continuously adjusted until the food temperature has reached a target temperature indicated by (a specific step of) the cooking recipe CR₁.

As should be readily understood, the use of cooking recipes involves high ease for the user. Indeed, the user is requested to select the food to be cooked, the degree of cooking, and/or type/level of food treatment, each selection corresponding to a cooking recipe having a specific temperature/time trend. This makes user selection simple and intuitive.

Moreover, the use of cooking recipes based on temperature/time trends allows performing automated cooking irrespective of coil/pan coupling. Thus, highly accurate and efficient automated cooking can be achieved, as cooking zone power is controlled according to a direct, thus precise food temperature sensing provided by temperature sensor Ts. This is in sharp contrast to known solutions making use of cooking recipes based on power/time trends, which are intrinsically error-bearing as the power actually transferred from coil to pan strongly depends on specific coil/pan coupling.

During cooking process, progress status of the cooking recipe CR₁, including cooking recipe steps already completed and when those steps were completed, is continuously updated, and stored, by the control unit. Additionally or alternatively, the progress status of the cooking recipe CR₁ can be stored by the temperature sensor Ts, in which case the progress status may be part of the information provided by the temperature sensor Ts.

Broadly speaking, the following steps of the smart cooking mode 200 are aimed at inferring whether the food has been moved from the first cooking zone 115₁ to a second cooking zone (e.g., the cooking zone 115₆) based on a de-association of the temperature sensor from the first cooking zone 115₁ and a re-association of the temperature sensor Ts to the second cooking zone 115₆, and continuing to run the ongoing cooking recipe CR₁ in the second cooking zone after food movement. Preferably (as herein assumed by way of example only), although not necessarily, said inferring may also be based, before or after temperature sensor Ts re-association, on pan detection, i.e. on detection of pan P₁ movement from the first cooking zone 115₁ to the second cooking zone 115₆ (or detection of any other pan in the second cooking zone 115₆).

Specifically, the control unit checks whether any pan (i.e., either the pan P₁ or any other pan) has been detected in the second cooking zone 115₆ (decision node 230). In the affirmative case (exit branch Y of the decision node 230), another check is performed aimed at determining whether the temperature sensor Ts has been re-associated to the second cooking zone (decision node 235), with such re-association to the second cooking zone that may follow manual de-association of the temperature sensor Ts from the first cooking zone 115₁, or preferably (as herein assumed by way of example) that may precede (i.e. cause) its automatic de-association therefrom. In the affirmative case (exit branch Y of the decision node 235), i.e. the temperature sensor Ts has been de-associated from the first cooking zone 115₁ and re-associated to the second cooking zone 115₆, the control unit infers that, e.g. due to cooking zones layout rearrangement, the user needs to change cooking zone for the ongoing cooking process (e.g., pan P₁ moved in the second cooking zone 115₆ together with the temperature sensor Ts, as illustrated in FIG. 5B scenario), or that the user has changed pan for the food under cooking (so that another pan P₂, different from the pan P₁, is detected in the second cooking zone 115₆, as illustrated in FIG. 5D scenario).

Whatever be the pan detected in the second cooking zone 115₆, the control unit then continues the cooking process in the second cooking zone 115₆ (action node 240). In order to achieve that, the power level of the second cooking zone 115₆ is automatically adjusted according to the cooking recipe CR₁ (starting from the progress status thereof) and to the current food temperature provided by the temperature sensor Ts. As should be promptly apparent, the power level at which the second cooking zone 115₆ is activated substantially corresponds to, but not necessarily equals, the last power level of the first cooking zone 115₁ indicated by the progress status. This because food may cool down during pan P₁ movement, food movement from pan P₁ to pan P₂, and/or temperature sensor Ts re-associations/de-associations, and transitory phases may be required before matching and following the trend indicated by the cooking recipe CR₁.

Meanwhile, the cooking process at the first cooking zone 115₁ may be stopped. For example, the control unit may be configured to switch the first cooking zone 115₁ off, i.e. power level substantially zero, or set and keep it on at a default power level, for example the last power level before temperature sensor Ts de-association/re-association.

In an alternative embodiment, not shown, after having performed operations of the action node 240, the control unit may further check whether pan P₁ is still detected in the first cooking zone 115₁, or not. In the affirmative case, the control unit may infer that the user would like to continue the existing cooking recipe CR₁ in the first cooking zone 115₁ without temperature feedback/control, for example because the temperature sensor Ts is intended to be used for other cooking processes. In this case, the control unit may also convert the temperature/time trend of the cooking recipe CR₁ into a corresponding power/time trend, e.g., by taking into account the electromagnetic properties of the coils and of a common pan, and automatically adjust the power level of the first cooking zone 115₁ according to the cooking recipe CR₁ (without temperature feedback/control), starting from the progress status thereof. In the negative case (pan P₁ being not detected in the first cooking zone 115₁ any longer), the cooking process at the first cooking zone 115₁ may be stopped, and the first cooking zone 115₁ switched off at a power level substantially zero (or kept on at default power level).

Back to the decision node 230, if no pan has been detected in the second cooking zone 115₆ (exit branch N), the cooking process goes on unchanged at the first cooking zone 115₁, as conceptually shown by loop connection between exit branch N of the decision node 230 and action node 225.

Similarly, if the temperature sensor Ts has not been re-associated to the second cooking zone 115₆ where pan P₁ has been moved or any other pan has been detected (exit branch N of the decision node 235), the cooking process goes on unchanged at the first cooking zone 115₁. This may happen, for example, when the user has to move the food from pan P₁, initially in the first cooking zone 115₁, to a different pan in the same first cooking zone 115₁ (pan P₁ detected in the second cooking zone 115₆), or when the user has to start a further cooking process in the second cooking zone 115₆ concurrently with the ongoing cooking process in the first cooking zone 115₁ (pan P₂ detected in the second cooking zone 115₆, while pan P₁ is still in the first cooking zone 1154

As should be appreciated, temperature sensor de-associations/re-associations and/or pan movements implement, de facto, easy gestures smartly recognizable by the induction hob. This strongly improves use experience and avoids continuous interaction by the user.

Although not shown, the smart cooking mode 200 may have recursive nature. This because the user may change many times pan P₁,P₂ and/or temperature sensor Ts positions during a cooking session. Thus, from action node 240 the operations flow may jump back to decision node 230 (or any other suitable decision or action node), so that any further pan detection and/or temperature sensor re-association can be smartly handled by the induction hob.

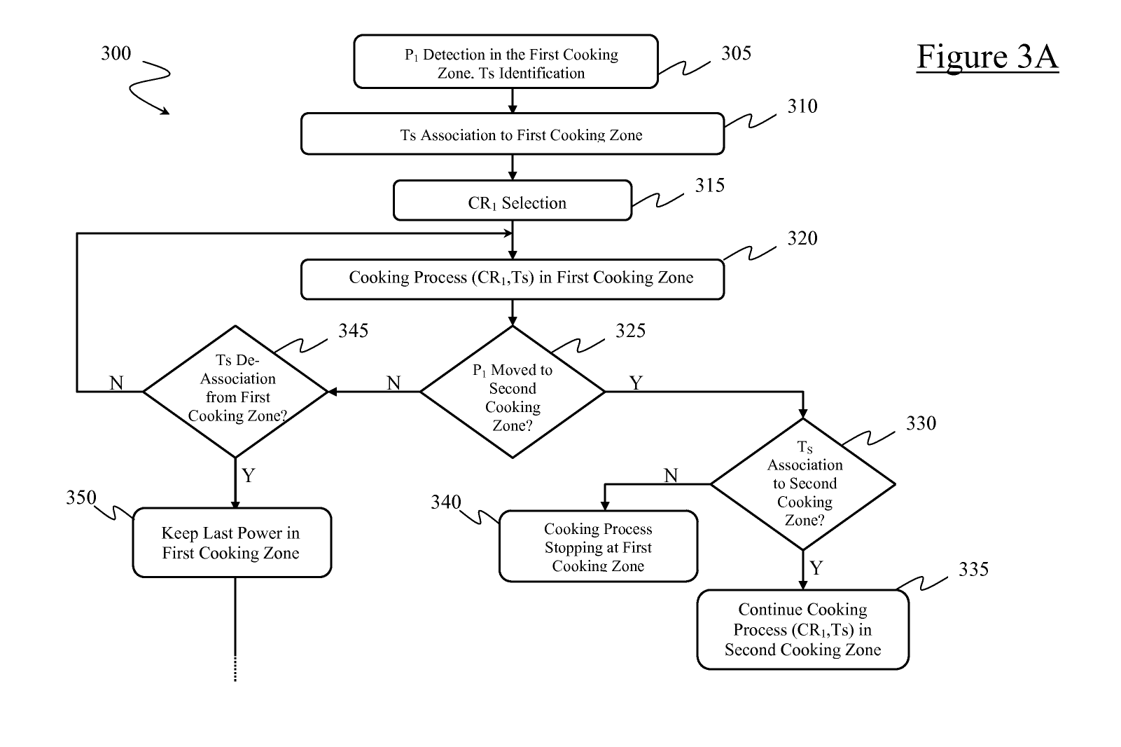

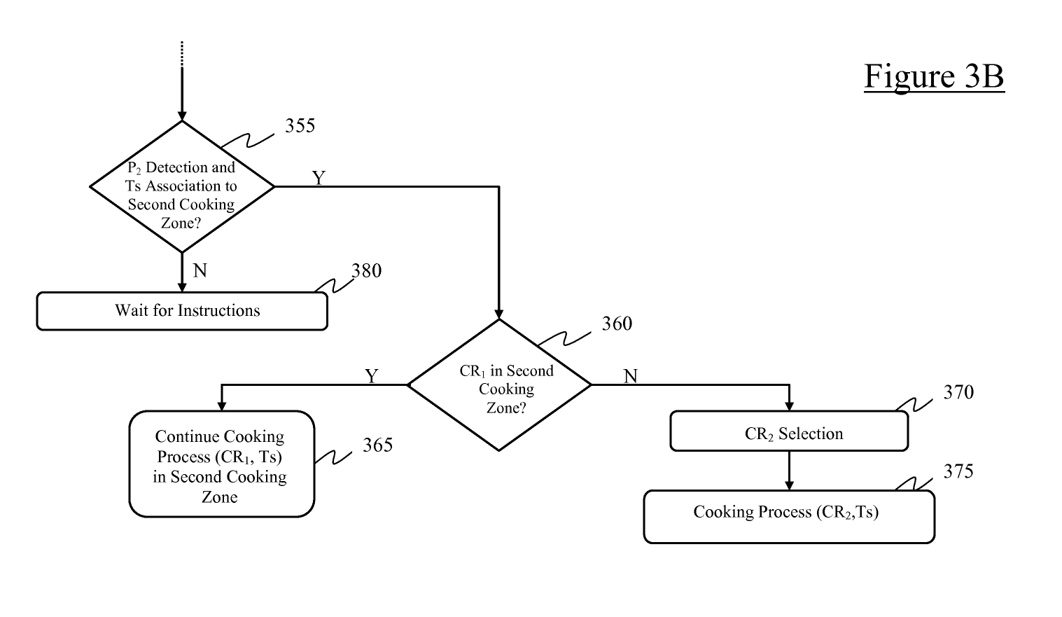

Turning now to FIGS. 3A-3B, they show a simplified activity diagram of a smart cooking mode 300 according to another embodiment of the present invention. For the sake of description ease and conciseness, from now on steps equal or similar to those of the smart cooking modes 200 will not be discussed again, and some steps will be grouped into single steps or split into different steps.

Smart cooking mode 300 operation can be summarized as follows (as before, with joint reference to FIGS. 5A-5D).

As discussed above, upon detection of pan P₁ in the first cooking zone 115₁ and temperature sensor Ts identification (action node 305), the user is requested to associate the identified temperature sensor Ts to the first cooking zone 115₁ (action node 215), thereafter he/she is requested to select or to set a cooking recipe CR₁ (action node 315).

Then, a cooking process is run under the control of the control unit (action node 320), which controls the driving circuit such as to automatically adjust power level of the cooking zone 115₁ according to the selected cooking recipe CR₁ and to current food temperature provided by the temperature sensor Ts.

The following steps of the smart cooking mode 300 are aimed at inferring whether the food has been moved from the first cooking zone 115₁ to the second cooking zone 115₆, and continuing to run the ongoing cooking recipe CR₁ in the second cooking zone 115₆ after food movement. In this respect, as will be understood from the description below, the smart cooking mode 300 differs from the smart cooking mode 200 in that inferring of food movement starts from detection of pan P₁ movement or temperature sensor Ts de-association from the first cooking zone 115₁. For the present embodiment, manual de-association of the temperature sensor Ts has been assumed, however nothing prevents from adapting (with a few changes) the smart cooking mode 300 to automatic de-association.

Specifically, the control unit checks whether pan P₁ movement has been detected (decision node 325). In the affirmative case (exit branch Y of the decision node 325), i.e. the pan P₁ has been moved from the first cooking zone 115₁ to the second cooking zone 115₆, the control unit checks whether the temperature sensor Ts has been re-associated to the same cooking zone as pan P₁ (decision node 330). In the affirmative case (exit branch Y of the decision node 330), the control unit infers that, e.g. due to cooking zones layout rearrangement, the user needs to change cooking zone for the ongoing cooking process. Such scenario is illustrated in FIG. 5B, showing both pan P₁ and temperature sensor Ts moved to the second cooking zone 115₆.

The control unit then continues the cooking process in the second cooking zone 115₆ (action node 335). In order to achieve that, the power level of the second cooking zone 115₆ is automatically adjusted according to the cooking recipe CR₁ (starting from the progress status thereof) and to the current food temperature provided by the temperature sensor Ts. As discussed above, the power level at which the second cooking zone 115₆ is activated substantially corresponds to, but not necessarily equals, the last power level of the first cooking zone 115₁ indicated by the progress status, and transitory phases may be required before matching and following the trend indicated by the cooking recipe CR₁.

Meanwhile, the cooking process at the first cooking zone 115₁ may be stopped. For example, the control unit may be configured to switch the first cooking zone 115₁ off, i.e. power level substantially zero, or keep it on at a default power level, for example the last power level before pan P₁ movement and/or temperature sensor Ts re-association.

Stopping of the cooking process at the first cooking zone 115₁ may also be performed where only pan P₁ has been moved to the second cooking zone 115₆ (exit branch N of the decision block 330 and action node 340). Such scenario is illustrated in FIG. 5C.

However, according to specific needs, such scenario may involve different operations by the control unit. For example, the control unit may infer that the user would like to continue the existing cooking recipe CR₁ in the second cooking zone 115₆ without temperature feedback/control, for example because the temperature sensor Ts is intended to be used for other cooking processes. In this case, the control unit may also convert the temperature/time trend of the cooking recipe CR₁ into a corresponding power/time trend, e.g., by taking into account the electromagnetic properties of the coils and of a common pan, and automatically adjust the power level of the second cooking zone 115₆ according to the cooking recipe CR₁ (without temperature feedback/control), starting from the progress status thereof—as before, the power level at which the second cooking zone 115₆ is activated may also provide transitory phases taking into account possible cooling down of food.

Back to the decision node 325, if no pan P₁ movement has been detected (exit branch N), the control unit checks (decision node 345) whether the temperature sensor Ts has been de-associated from the first cooking zone 115₁ (manually, as herein assumed, or automatically, as in response to the re-association of the temperature sensor Ts to another cooking zone). In the negative case, the cooking process goes on unchanged at the first cooking zone 115₁, as conceptually shown by loop connection between exit branch N of the decision node 345 and action node 320.

In the affirmative case (exit branch Y of the decision node 345), i.e. in case of temperature sensor Ts de-association, the control unit may alternatively:
keep the first cooking zone 115₁ on at a default power level, for example the last power level before de-association (action node 350);
infer that the user would like to continue the existing cooking process in the first cooking zone 115₁ without temperature feedback/control, and automatically adjust the power level of the first cooking zone 115₁ according to the cooking recipe CR₁ only;
set to zero the power level of the first cooking zone 115₁.

Then, the control unit checks whether the temperature sensor Ts has been re-associated to another cooking zone wherein another pan P₂ has been detected (decision node 355).

In the affirmative case, as illustrated in FIG. 5D scenario showing pan P₁ in the first cooking zone 115₁ and temperature sensor Ts within second cooking zone 115₆ together with pan P₂, the control unit infers that food previously contained within pan P₁ has been moved into pan P₂ (e.g., due to pan size issues, or any other user need), or that the cooking process at the first cooking zone 115₁ does not need temperature control any longer and another cooking recipe at another cooking zone, e.g. at the second cooking zone 115₆, instead does.

Then, the user is requested (decision node 360) to select the existing cooking recipe CR₁, or another cooking recipe. If the existing cooking recipe CR₁ is selected (exit branch Y of the decision node 360), the cooking process is continued in the second cooking zone 115₆ (action node 365)—as discussed for action node 335. Otherwise (exit branch N of the decision node 360), upon selection of another cooking recipe CR₂ (action node 370), a new cooking process is performed at the second cooking zone 115₆ by automatically adjusting the power level thereof according to the selected cooking recipe CR₂ and to current food temperature provided by the temperature sensor Ts.

Back to the decision node 355, if no temperature sensor Ts re-association has been performed by the user, or until no new pan has been detected in the cooking zone which the temperature sensor Ts has been re-associated thereto, the control unit waits for further user selections, e.g., for starting a new smart cooking mode cycle (decision node 380).

As discussed above, the smart cooking mode 300 may have recursive nature. This because the user may change many times pan P₁,P₂ and/or temperature sensor Ts position during a cooking session. Thus, from action nodes 335, 365 and 375 the operations flow may jump back to decision node 325 (or any other suitable decision or action node), so that any further pan P₁,P₂ movements and/or temperature sensor Ts de-associations/re-associations can be smartly handled by the induction hob.

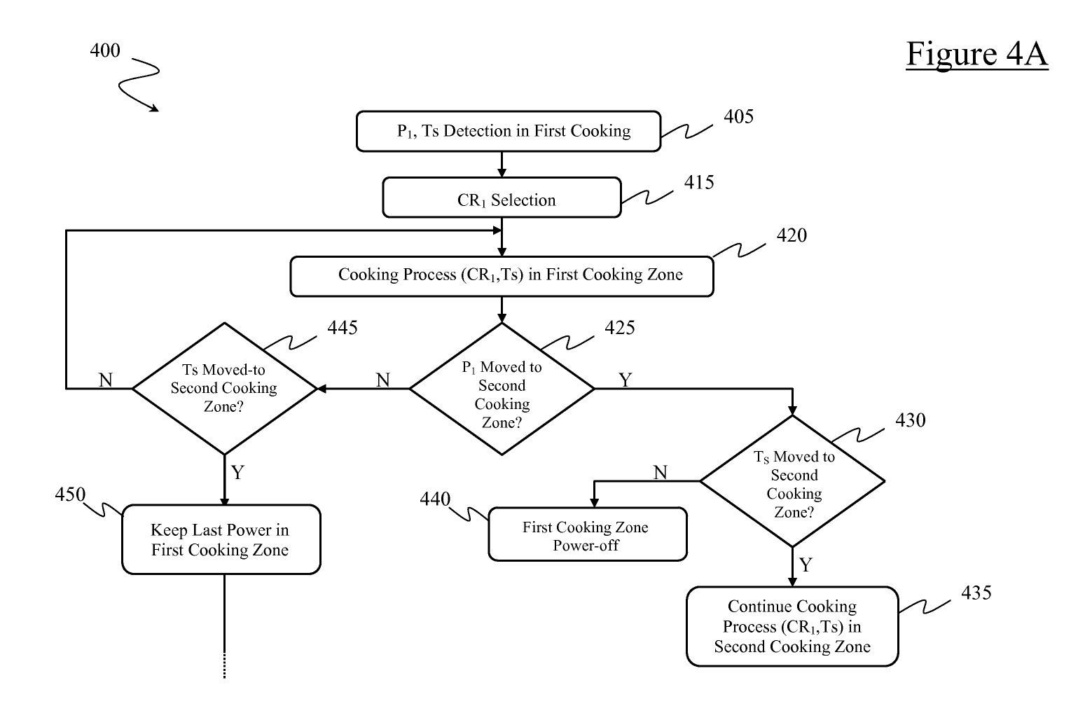

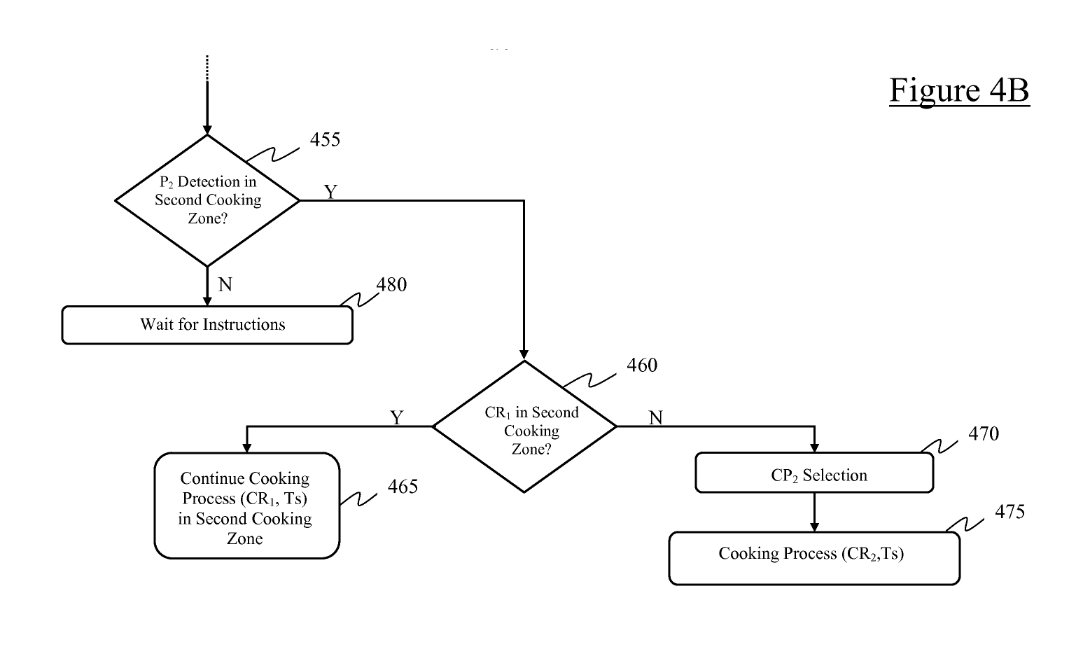

FIGS. 4A-4B show a simplified activity diagram of a smart cooking mode 400 according to a further embodiment of the present invention.

In the example at issue, the temperature sensor Ts is also configured to communicate information (such as identifier and position signaling) that allows temperature sensor Ts automatic detection, i.e. automatic detection of position and movement of the temperature sensor Ts. From now on, automatic temperature sensor Ts detection is assumed to involve also automatic temperature sensor Ts re-association to the cooking zone(s) where it is detected, and automatic temperature sensor Ts de-association from the previous cooking zone(s). Similarly, automatic pan detection is assumed to involve also automatic pan re-association to the cooking zone(s) where it is detected, and automatic pan de-association from the previous cooking zone(s).

Smart cooking mode 400 operation can be summarized as follows.

As discussed above, upon detection of pan P₁ and temperature sensor Ts (action node 405), and automatic re-association thereof to the first cooking zone 115₁, the user is requested (action node 415) to select the cooking recipe CR₁, thereafter a cooking process is run under the control of the control unit (action node 420).

Upon detection of both pan P₁ and temperature sensor Ts movement from the first cooking zone 115₁ to the second cooking zone 115₆ (exit branches Y of decision nodes 425 and 430), and automatic de-association thereof from the first cooking zone 115₁ and automatic re-association thereof to the second cooking zone 115₆, the cooking process is continued in the second cooking zone 115₆ (action node 435).

Meanwhile, the cooking process at the first cooking zone 115₁ is stopped—for example, by switching the first cooking zone 115₁ off, or by keeping it on at a default power level, as above discussed.

If instead only pan P₁ movement from the first cooking zone 115₁ to the second cooking zone 115₆ is detected (see exit branch Y of decision node 425 and exit branch N of decision node 430), the cooking process at the first cooking zone 115₁ is stopped (and the first cooking zone 115₁ switched-off or kept at a default value of operated for allowing the cooking recipe CR₁ without temperature feedback/control, as above discussed)-action node 440.

On the other hand, if only temperature sensor Ts movement from the first cooking zone 115₁ is detected (see exit branch N of decision node 425 and exit branch Y of decision node 445), the temperature sensor Ts is automatically de-associated from the first cooking zone 115₁, and the first cooking zone 115₁ kept on at a default power level, for example the last power level before temperature sensor Ts de-association/movement (action node 450).

If the temperature sensor Ts has been moved to the second cooking zone 115₆ where another pan P₂ has been detected (exit branch Y of the decision node 455), after automatic re-association of the temperature sensor Ts and automatic association of the pan P₂ to the second cooking zone 115₆, the user is requested to select the existing cooking recipe CR₁, or another cooking recipe (decision node 460). On the contrary, if no pan P₂ is detected in the second cooking zone 115₆ (exit branch N of the decision node 455), further instructions by the user are waited (action node 480).

If the existing cooking recipe CR₁ is selected, the cooking process is continued in the second cooking zone 115₆ (action node 465)—as discussed for action node 435. Otherwise, upon selection of another cooking recipe CR₂ (action node 470), a new cooking process is started at the second cooking zone 115₆ by automatically adjusting the power level thereof according to the selected cooking recipe CR₂ and to current food temperature provided by the temperature sensor Ts.

Naturally, in order to satisfy local and specific requirements, a person skilled in the art may apply to the solution described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details (such as the numeric examples) set forth in the preceding description for providing a more thorough understanding thereof; on the contrary, well known features may have been omitted or simplified in order not to obscure the description with unnecessary particulars. Moreover, it is expressly intended that specific elements and/or method steps described in connection with any disclosed embodiment of the invention may be incorporated in any other embodiment as a matter of general design choice.

For example, the solution according to an embodiment of the invention lends itself to be implemented through an equivalent method (by using similar steps, removing some steps being not essential, or adding further optional steps); moreover, the steps may be performed in different order, concurrently or in an interleaved way (at least partly).

Moreover, analogous considerations apply if the cooking hob has a different structure or comprises equivalent components, or it has other operating features. In any case, any component thereof may be separated into several elements, or two or more components may be combined into a single element; in addition, each component may be replicated for supporting the execution of the corresponding operations in parallel. It should also be noted that any interaction between different components generally does not need to be continuous (unless otherwise indicated), and it may be both direct and indirect through one or more intermediaries.

For example, although explicit reference has been made to an induction hob, this should not be construed limitatively. With modifications that will be apparent to a person skilled in the art, the present invention may be applied to any cooking hob, for example a gas cooking hob or a resistive cooking hob.

1. A method for operating a cooking hob comprising at least a first and a second cooking zones and a control unit configured for controlling the first and second cooking zones, the method comprising the following steps executed by the control unit:
associating a pan containing food to be cooked to the first cooking zone,
associating a food temperature sensor to the first cooking zone, the food temperature sensor being configured to be in direct contact with the food to be cooked and to communicate to the control unit an indication of the food temperature,
automatically adjusting a power level of the first cooking zone according to a cooking recipe and to the current food temperature provided by the food temperature sensor,
inferring that the food has been moved from the first cooking zone to the second cooking zone based on a de-association of the food temperature sensor from the first cooking zone and a re-association of the food temperature sensor to the second cooking zone, and
automatically adjusting the power level of the second cooking zone according to the cooking recipe and to the current food temperature provided by the food temperature sensor, starting from a progress status of the cooking recipe at the first cooking zone before moving the food.

2. A method according to claim 1, wherein said inferring is further based on:
de-association of the pan from the first cooking zone and re-association of the pan to the second cooking zone, or
association of a further pan to the second cooking zone.

3. A method according to claim 2, further comprising:
inferring that the food has not been moved from the first cooking zone to the second cooking zone based on:
no de-association of the pan from the first cooking zone and no re-association of the pan to the second cooking zone, or
no association of the further pan to the second cooking zone; and
automatically adjusting the power level of the first cooking zone.

4. A method according to claim 1, wherein said inferring is further based on de-association of the pan from the first cooking zone and re-association of the pan to the second cooking zone.

5. A method according to claim 4, wherein said inferring is further based on:
no de-association of the pan from the first cooking zone and no re-association of the pan to the second cooking zone,
association of a further pan to the second cooking zone, and
selection of the cooking recipe for the second cooking zone.

6. A method according to claim 5, wherein upon
no de-association of the pan from the first cooking zone and no re-association of the pan to the second cooking zone,
association of the further pan to the second cooking zone, and
selection of a further cooking recipe for the second cooking zone,
the method further comprises automatically adjusting the power level of the second cooking zone according to the further cooking recipe and to current food temperature provided by the food temperature sensor.

7. A method according to claim 6, further comprising:
inferring that the food has not been moved from the first cooking zone to the second cooking zone based on:
no de-association of the pan from the first cooking zone and no re-association of the pan to the second cooking zone, or
no association of the further pan to the second cooking zone; and
automatically adjusting the power level of the first cooking zone.

8. A method according to claim 3, wherein said automatically adjusting the power level of the first cooking zone comprises automatically setting the power level of the first cooking zone at a predefined power level.

9. A method according to claim 8, wherein said predefined power level is set according to a progress status of the cooking recipe before de-association of the temperature sensor from the first cooking zone.

10. A method according to claim 3, wherein said automatically adjusting the power level of the first cooking zone comprises automatically adjusting the power level of the first cooking zone according to the cooking recipe, starting from the progress status thereof before de-association of the temperature sensor from the first cooking zone.

11. A method according to claim 1, further comprising, before said de-association of the food temperature sensor from the first cooking zone and re-association of the food temperature sensor to the second cooking zone, automatically detecting food temperature sensor movement from the first cooking zone to the second cooking zone.

12. A method according to claim 4, further comprising, before said de-association of the pan from the first cooking zone and re-association of the pan to the second cooking zone, automatically detecting pan movement from the first cooking zone to the second cooking zone.

13. A cooking hob comprising:
at least first and second cooking zones; and
a control unit configured for:
associating a pan containing food to be cooked to the first cooking zone,
associating a food temperature sensor to the first cooking zone, the temperature sensor being configured to be in direct contact with the food to be cooked and to communicate to the control unit an indication of the food temperature,
automatically adjusting a power level of the first cooking zone according to a cooking recipe and to the current food temperature provided by the food temperature sensor,
inferring that the food has been moved from the first cooking zone to the second cooking zone based on a de-association of the food temperature sensor from the first cooking zone and a re-association of the food temperature sensor to the second cooking zone, and
automatically adjusting the power level of the second cooking zone according to the cooking recipe and to the current food temperature provided by the food temperature sensor, starting from a progress status of the cooking recipe at the first cooking zone before moving the food.

14. A cooking hob according to claim 13, further comprising at least one electronic module allowing information exchange between the control unit and the food temperature sensor.

15. A cooking hob according to claim 14, wherein said at least one electronic module comprises a wireless electronic module configured for:
wireless exchange of said information with the temperature sensor, and
wired exchange of said information with the control unit.

16. A cooking hob according to claim 13, wherein the cooking hob comprises an induction hob.
